(19) United States
(12) Patent Application Publication
(10) Pub. No.: US 2025/0146281 A1
(43) Pub. Date: May 8, 2025

(54) A COMPOSITE BEAM

(71) Applicant: 5B IP Holdings Pty Ltd, Mascot (AU)

(72) Inventors: Lloyd Christopher Niccol, Mascot (AU); Victor Cintra Rego, Mascot (BR); Thomason James Sobey, Mascot (AU); Wayne Alan Baker, Mascot (ZA); Martin James Lunney, Mascot (AU)

(73) Assignee: 5B IP Holdings Pty Ltd, Mascot, NS (AU)

(21) Appl. No.: 18/940,307

(22) Filed: Nov. 7, 2024

(30) Foreign Application Priority Data
Nov. 8, 2023 (AU) 2023903585

(51) Int. Cl. E04C 3/293; H02S 20/20

(52) U.S. Cl. CPC E04C 3/293; H02S 20/20

(57) ABSTRACT

An elongate composite beam 26 for securing or anchoring a solar array 10. The beam 26 comprising a hollow outer shell 28 formed from a C-section beam that has a closed end wall 30, a pair of side walls 32, and end wall sections 34, 36 that extend inwardly towards each other from ends of the side walls 32. Opposed ends of the end wall sections 34, 36 are spaced apart to define an elongate gap G. The closed end wall 30, the side walls 32 and the end wall sections 34, 36 define a shell interior. At least one of the end wall sections 34, 36 comprises an inwardly extending lip 38, 40 that extends in a direction towards the closed end wall 30 inwardly into the shell interior. The shell interior is substantially filled with a settable material 42 which engages about the inwardly extending lip 38, 40.

### PRIORITY CROSS-REFERENCE

The present application claims priority from Australian Provisional Patent Application No. 2023903585 filed 8 Nov. 2023 the contents of which is to be considered to be incorporated into this specification by this reference.

### TECHNICAL FIELD

The present invention relates to a composite beam, in particular a composite beam that can be used to mount a photovoltaic (PV) array on the ground or another mounting surface.

### BACKGROUND OF THE INVENTION

The discussion of the background to the invention that follows is intended to facilitate an understanding of the invention. However, it should be appreciated that the discussion is not an acknowledgement or admission that any aspect of the discussion was part of the common general knowledge as at the priority date of the application.

Composite beams can be beams that are formed from at least two different components or materials. Where the composite beam is formed from at least two different materials, these materials can be steel and concrete.

Composite beams can comprise a hollow metallic beam that is filled with concrete. These concrete composite beams are used in the construction industry already. The combination of a hollow metallic beam with a concrete filling can provide increased beam strength with low additional cost.

Some concrete composite beams employ a closed hollow metallic section, such as a square or rectangular section, and concrete is poured into the section from an end of the section or through an opening formed in a wall of the section. However, closed metallic sections (usually steel sections) are relatively difficult and expensive to produce, and have several limitations. For example, if the steel section is closed using a rolled seam, it is necessary to use a grade of steel that can undergo the rolling deformation without cracking. These grades are typically lower strength, and accordingly, they limit the capacity of a subsequently formed composite beam, unless thicker steel is used to increase the strength. This increase in thickness increases the direct cost of a composite beam and increases the processing time and cost of the roll forming machinery suitable to manufacture the section. In particular, rolled seam beams require complex roll forming machines which are typically costly, uncommon and difficult to procure.

In addition, the very tight bend radius of the seams often causes cracking of coating applied to the steel, compromising the performance of the composite beam in high corrosion environments.

Other methods for producing a closed steel section include seam welding a section closed, or using hot dip galvanized rectangular hollow section (RHS). However, seam welding can damage the steel coating, thus impacting corrosion performance and also requiring costly equipment, while hot dip galvanizing an RHS introduces additional batch processing steps and is a very costly process.

There are also composite beams that employ open sections, such as C-sections. Open sections do not have the drawbacks associated with closure of the section, however, for open section concrete-filled beams, the resulting strength of the composite beam can be insufficient for requirements (principally because of the open section) although strength can be improved by bracing the composite beam across the opening or employing studs to pass through the wall of the section and into the concrete to secure the concrete within the section to the section. Obviously, the use of bracing and/or studs adds to the manufacturing process and may interfere with the operation of the composite beam, ie the way it interacts with the components it is to support.

Concrete-filled composite beams can be used in the solar industry for securing, anchoring or mounting a solar PV array on the ground or another mounting surface. One example of a relevant solar PV array is the foldable solar PV array commercialized by the applicant and disclosed in AU Patent 2016374498. In Patent 2016374498, elongate beams mount the PV array to a mounting surface, such as a ground surface, and the beams act as a ballast for the PV array and secure the foldable modules or panels of the PV array together. The beams are also utilised when the PV array is moved to a deployment location such as by a telehandler or forklift, rather than engaging the modules of the PV array directly. The beams can thus include openings for receipt of forklift tynes for lifting and moving the PV array by a forklift.

AU Patent 2016374498 describes that the beams can be formed from any suitable material, including metal, polymer or plastic, timber or concrete, but explains that concrete beams are preferred as they can provide a mass or weight that assists to securely position the solar PV array in an opened and installed position. The mass or weight of the concrete beams can provide structural rigidity in the direction transverse to the direction in which the PV array is opened and closed, while forklift tyne openings and hinges can be cast into the concrete beams, the latter being for the attachment of the PV modules. Casting of the mounting beams in concrete is also relatively easy, as concrete casting technology is well known. However, concrete beams can be damaged during handling or transport and therefore they need to be handled with care. Encasing the concrete in a steel shell can make the beam more robust and durable for transport and can also reduce packaging and handling requirements.

The solar industry is heavily driven by cost, safety, and maintaining performance over long periods of time often under harsh conditions. This requires that minimisation of the use of different materials and the number of components used, while ensuring high durability.

The cost of composite beams that employ closed hollow metallic sections thus prohibitive, while the use of open sections is unattractive by virtue of the reduced beam strength.

The present disclosure aims to provide a composite beam specific for use in the solar industry for mounting a photovoltaic (PV) array on the ground or another mounting surface and that overcomes disadvantages of the prior art, or that at least provides a useful alternative to the prior art.

### SUMMARY OF THE INVENTION

The present disclosure relates to a composite elongate beam, steel/concrete for example, in which the steel section is a C-section. In a form of the present disclosure, an elongate composite beam for securing or anchoring a solar array is provided comprising:
a. a hollow outer shell formed from a steel C-section beam that has a closed end wall, a pair of side walls extending from the end wall, end wall sections that extend inwardly towards each other from ends of the side walls remote from the closed end wall, opposed ends of the end wall sections being spaced apart to define an elongate gap between the end wall sections, the closed end wall, the side walls and the end wall sections defining a shell interior, and at least one of the end wall sections comprising an inwardly extending lip that extends in a direction towards the closed end wall inwardly into the interior, and
b. the interior of the shell being substantially filled with a settable material which engages about the inwardly extending lip.

A composite beam according to the present disclosure employs an outer shell that is an open section in the form of a C-section, which brings with it the advantages of the use of open sections as compared to closed sections. The C-section can be formed from high strength, precoated steels, whereby the geometry of the C-section is controlled to maximise the likelihood of the metallic coating remaining undamaged and thus ensuring satisfactory corrosion performance.

The C-section beam of the present disclosure can have a simple C shape so that it has a pair of side walls extending generally perpendicular to the end wall and generally parallel to each other. However, the C-section beam of the present disclosure can have different shapes, such as trapezoidal.

However, noting the drawbacks discussed above in relation to the use of open sections, the present disclosure employs an inwardly extending lip about which the settable material within the beam sets and engages when the settable material sets within the interior of the shell. The settable material fills the interior of the shell and extends about the lip, so that the settable material engages about the lip, or envelopes, embeds or encases the lip. This restrains lip from buckling and this in turn stiffens the end wall section from which the lip extends, so that the shell is strengthened.

In forms of the invention developed to date, the settable material has been concrete and thus for convenience of description hereinafter, reference will be made to concrete as the settable material. It should be appreciated however, that where concrete is referred to, other settable materials may be substituted if suitable alternative settable materials exist.

The concrete within the interior of the shell bridges across the gap between the end wall sections and once the concrete has set or cured, the composite beam behaves like a closed section. Shear and torsion applied to the composite beam will be transferred from one side of the beam to the other by the concrete within the beam. This is particularly important under bending and biaxial loading, as elongate open channel sections are otherwise susceptible to torsion and buckling.

The engagement between the lip and the concrete also locks the shell to the concrete, limiting the possibility that the shell might delaminate from the concrete, thereby further improving its strength. In prior art arrangements, concrete composite beams made from C-sections without the inwardly extending lip of the present disclosure have been shown to fail by the end wall sections delaminating from the concrete.

The inwardly extending lip can extend at an acute or an obtuse angle to the end wall section from which it extends. Alternatively, the inwardly extending lip can extend generally perpendicular to the closed end wall and thus generally parallel to the end wall section from which it extends.

The inwardly extending lip can have any suitable height dimension measured from the end wall section from which it extends to a free edge spaced from the end wall section. In some forms of a composite beam according to the present disclosure, the height of the lip can be ⅓^{rd} to 1/20^{th} of the height of the side walls between the closed end wall and the end wall sections. In some forms of a composite beam according to the present disclosure, the height of the lip can be about 1/10^{th} of the height of the side walls between the closed end wall and the end wall sections. In some forms of a composite beam according to the present disclosure, the dimensions of the closed end wall, the side walls and the end wall sections are respectively: 110×150×35×18. The length of the composite beam can be in the order of 1 m to 6 m.

A composite beam according to the present disclosure can comprise inwardly extending lips extending from each of the end wall sections. The inwardly extending lips will be spaced apart and will extend along the elongate gap. Where an inwardly extending lip extends from each of the end wall sections, the strength of the composite beam can be increased for the same reasons as provided where only one of the end wall sections comprises an inwardly extending lip. Where an inwardly extending lip extends from each of the end wall sections, the concrete within the interior of the shell concrete fills the interior of the shell and extends about each of the lips, so that the concrete engages about the lips, or envelopes, embeds or encases the lips.

Where an inwardly extending lip extends from each of the end wall sections, the inwardly extending lips can have the same dimensions, so that the inwardly extending lips are substantially the same as each other.

The inwardly extending lips can extend for the full length of the shell. The inwardly extending lips can have a constant height along the full length of the shell.

In concrete composite beams according to the present disclosure, the steel can be G450 ZM250 and the wall thickness of the shell can 0.5 mm to 3 mm.

The outer shell can comprise one or more openings through which concrete can be fed or pumped into the shell.

The outer shell can also or alternatively comprise one or more openings for receipt of or to accommodate one or more studs. The one or more studs can extend through an opening in the wall of the shell and into the concrete. A stud can be inserted through an opening in the wall of the shell prior to concrete being fed or pumped into the shell, or concrete can be fed or pumped into the shell and subsequently a stud can be inserted through an opening and into the concrete. In the latter approach, the stud must be inserted through an opening and into the concrete prior to the concrete curing.

A stud can be shaped or configured to interlock with the concrete once the concrete has cured. In some forms of a composite beam according to the present disclosure, the stud has an embedded section which is the section of the stud that extends into the concrete and the embedded section has an expansion that forms an undercut so that once the concrete has cured about the embedded section, the expansion section interlocks with the concrete to resist removal of the stud out of the opening from the composite beam. In some forms of a composite beam according to the present disclosure, the stud can comprise a head, a neck that is connected to the head, and a shoulder that is connected to the neck, remote from the head, whereby the head abuts against an outer surface of the shell to limit penetration of the stud into the shell, and the shoulder forms an undercut to interlock with the concrete. The stud can be formed from plate with generally flat and parallel side surfaces, so that the opening in the wall of the shell can be generally rectangular.

The stud can provide a structural connection between a PV module connected to the composite beam and the composite beam so that there is improved performance of the PV array in very high wind and/or snow conditions, and during seismic loads. Given their configuration with respect to the beam and the concrete, the studs reduce the risk of failure due to corrosion. This is because, for the stud to be able to be pulled out of the concrete, the stud must undergo a large loss of its steel section. This is distinct from, for example, a rivet or rivnut which requires a much smaller to be pulled free from the concrete. This loss of steel section could occur for example by corrosion in the shell. Also, a rivet or rivnut will often be of a different material to the shell and this can lead to galvanic corrosion. There can also be the introduction of areas or surfaces, particularly on a flat horizontal surface, that can accumulate debris and which can lead to accelerated corrosion and pitting at the interfaces between the rivet or rivnut and the shell. These downsides can be avoided by the studs having a large galavnised section that forms a large embedment surface in the concrete which will be far less impacted by a small loss of steel section at the interface with the shell surface.

The stud can comprise a head and a neck, or a head, a neck and a shoulder. That is, the shoulder can be provided if required. The stud can assist to prevent movement of the concrete within the outer shell relative to the outer shell and thus assists to limit the possibility that the shell might delaminate from the concrete and by this arrangement, the strength of the beam can be increased.

The head of the stud can be in contact with the shell, such as with a facing surface of the shell and the stud can be formed from an electrically conductive metal, such as steel, so that the stud can form an electrical bond with the shell and can then contribute to providing an electrical path to ground for items connected to the composite beam.

The head of the stud can also comprise connection points for connection to lifting machinery for example, either for lifting the composite beam, or for lifting a PV array which is connected to a composite beam. The stud can alternatively be used for jigging, or for packaging or bracing of the composite beam.

The stud or studs can project from an upper surface of the composite beam so that the other surfaces of the composite beam are free from projections and so that the composite beam can be packed together side by side without the stud or studs interfering with the packing. This also allows the composite beam to sit flat on a ground or supporting surface and to be able to be slid along that surface.

The opening through which the stud extends through the outer shell can form a friction fit with the stud so that the stud can be quickly inserted into the opening and then held within the opening without any further securing or fixing components. Side walls of the stud can inclined so that the sidewalls engage against edges of the opening and frictionally engage the edges with greater force the further the stud is pushed into the opening. Where the stud includes a head as above described, the maximum frictional engagement can be achieved when the head engages against the facing outer surface of the shell. The sections of the opening that are frictionally engaged by the stud can include foldable tabs that fold inwardly into the interior of the shell as frictional engagement between the side walls of the stud and the tabs increase, whereby the tabs form barbs against the side walls resisting reverse movement of the stud out of the opening. The stud can be arranged to form a press fit within the opening. The electrical bond discussed above can be achieved by the frictional engagement discussed above.

In some forms of a composite beam according to the present disclosure, multiple studs are employed along the length of the composite beam. In other forms of composite beam according to the present disclosure, a pair of studs is employed at each end of the beam with the studs of each pair of studs being spaced apart along the length of the composite beam.

In some forms of a composite beam according to the present disclosure, a closure member is employed to close the elongate gap between the end wall sections. Advantageously, closure of the gap prevents flow of cement through the gap and out of the interior of the outer shell when cement is being fed into the interior of the outer shell. In some forms of the present disclosure, the closure member is elongate and has a length substantially equal to the length of the outer shell.

The closure member extends or bridges across the gap to form a barrier against passage of cement through the gap. The closure member can connect to the inwardly extending lip of the end wall section and in one form, the closure member comprises a recess to closely receive at least a portion of the lip. The recess can have a depth substantially equal to the height of the lip, or it can have a depth which is less than the height of the lip. The recess can be a close and friction fit with the lip, or it can be a loose fit. The recess can be formed in a side wall of the closure member. The closure member can thus comprise a recess and a bridging member that extends across the gap.

Where a composite beam according to the present disclosure comprises inwardly extending lips extending from each of the end wall sections, the closure member can comprise a pair of recesses to closely receive at least a portion of each of the lips. The recesses can be formed in opposite side walls of the closure member. The closure member can thus comprise a pair of spaced apart recesses and a bridging member that extends between the recesses and across the gap.

The closure member can be a non-structural part of the composite beam, so that the closure member can be formed from plastic for example and have sufficient strength only to prevent flow of cement out of the gap. A suitable plastic can be PVC. Alternatively, the closure member can be formed from a metal for example and form a structural part of the composite beam, although this is considered unnecessary, given that the interaction between the inwardly extending lip or lips and the concrete is considered to provide sufficient structural integrity without requiring the closure member to provide additional structural integrity. Advantageously, this means that the closure member can be manufactured cheaply and without long term durability in mind. Once the cement has cured, the closure member is no longer operational and while it is acceptable for the closure member to be maintained in the closure position, it remains in that position simply because it would be difficult to remove and there is no point in doing so.

In addition to the closure member discussed above, end caps can also be installed to close each end of the outer shell prior to cement being fed into the interior of the shell. Again, these end caps can be non-structural and made of plastic to reduce cost. Alternatively, because the end caps will be relatively small and relatively cheap, they can alternatively be stamped from plate metal if preferred.

It is expected that a composite beam according to the present disclosure can be manufactured to perform to required specification for mounting a solar PV array on the ground or another mounting surface, for more than 30 years in high corrosion environments. It is further expected that the elongate structural beam can be designed and manufactured at a minimal cross-sectional area required to withstand significant applied biaxial loads. This means it is expected that the elongate structural beam can be designed and manufactured at minimal cost. In addition, the composite beam and metallic attachments can be electrically connected with low resistance, so that they form an equipotential bonding path to an earth, where required.

It has been described above that concrete-filled composite beams are attractive because the hollow metallic beams or shells can be delivered to site at minimum weight and with increased ease of handling, and filled on site with concrete. It is to be noted that while this is in fact a significant benefit provided by the present disclosure, it is still an option for the beams or shells to be filled with concrete at the site of manufacture and then delivered as a concrete composite beam to the installation site.

Moreover, manufacturers of PV arrays can choose whether they connect the composite beams to the arrays at the manufacturing site, or whether they connect them at the installation site. While the benefit of reduced weight for transport and storage with active to some manufacturers and installers, other manufacturers and installers may still prefer the composite beam but using it in the traditional way that concrete beams are currently used. The composite beam may provide performance advantages over concrete beams by the addition of the external metallic shell, for example to improve impact resistance that the beams may be subject to and, as indicated above, the external metallic shell can provide the ability to earth the beams.

In some forms of a composite beam according to the present disclosure, the internal filling material is a polymer-based material, rather than concrete.

### BRIEF DESCRIPTION OF THE DRAWINGS

In order that the invention may be more fully understood, some embodiments will now be described with reference to the figures in which:

FIG. 1 illustrates a PV array that includes a plurality of PV modules shown in an open “east west” configuration.

FIG. 2 is a side view of a forklift lifting the PV array of FIG. 1 in a folded or collapsed condition.

FIG. 3 is a side view of a forklift deploying the PV array of FIG. 1.

FIG. 4 shows a composite beam according to one form of the present disclosure.

FIG. 5 shows the composite beam of FIG. 4 in a partly exploded view.

FIG. 6 is an end view of the outer shell of the composite beam of FIGS. 4 and 5.

FIG. 7 is an end view of the composite beam of FIGS. 4 and 5.

FIGS. 8 and 9 are exploded and assembled views respectively of one end of the composite beam of FIGS. 4 and 5.

FIG. 10 is a cross sectional view taken through IX-IX of FIG. 9.

### DETAILED DESCRIPTION

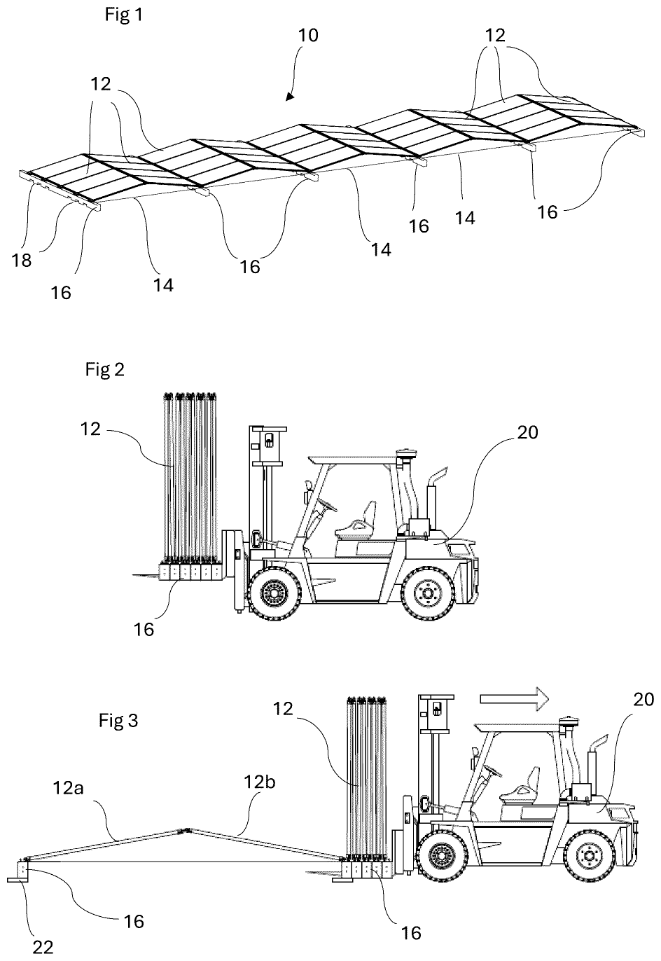

FIG. 1 illustrates a PV array 10 that includes a plurality of PV modules 12 shown in an open “east west” configuration. The modules 12 are all disposed at the same angle to each other and are retained in that position by a flexible tether 14. Discussion of the use of a tether to retain the east west configuration is found in International Patent Application No. PCT/AU2015/050603, the contents of which are incorporated herein by this cross-reference.

The PV array 10 employs concrete rails or beams 16 which are provided at each of the ends of the array 10 and at the hinged connections between adjacent modules 12 that would otherwise rest on or engage against a ground or mounting surface on which the PV array 10 is deployed or installed.

The beams 16 advantageously include forklift tyne openings 18, which are cast into the beams and provide access for forklift lifting and movement of the modules 12 of the array 10. Each of the beams 16 includes the tyne openings 18 and the provision of those openings allows a forklift 20 to engage and lift a folded group of modules 12 as shown in FIG. 2. The forklift 20 can then deploy the modules 12 as shown in FIG. 3, by lowering the folded group of modules 12 so that the beam 16 of the front or leading module 12a rests on the mounting surface 22 and then the forklift 20 reverses to unfold the leading module 12a and the connected module 12b to the east west configuration. The unfolding process continues until the array 10 is fully deployed as shown in FIG. 1.

As indicated earlier, the beams 16 can also provide a form of ballast for the PV array 10 in order to securely locate the PV array 10 in place, while it also provides structural rigidity against twisting movement about the longitudinal axis of the array 10.

The use of concrete beams is advantageous for the forgoing reasons, but there are also disadvantages in that the weight of the array 10 is increased for transport and storage by the beams themselves being heavy. Other disadvantages include that concrete beams have limited strength, are fragile, are difficult to jig and maintain tolerance, are expensive and are slow to manufacture. As will be apparent from the preceding discussion, the present disclosure proposes a composite elongate beam in which the section is a C-section, particularly a steel C-section, whereby the C-section optionally can be filled with a settable material, such as concrete. This can be done off site or on site. The composite elongate beam of the present disclosure provides advantages by the composite construction of the composite beam.

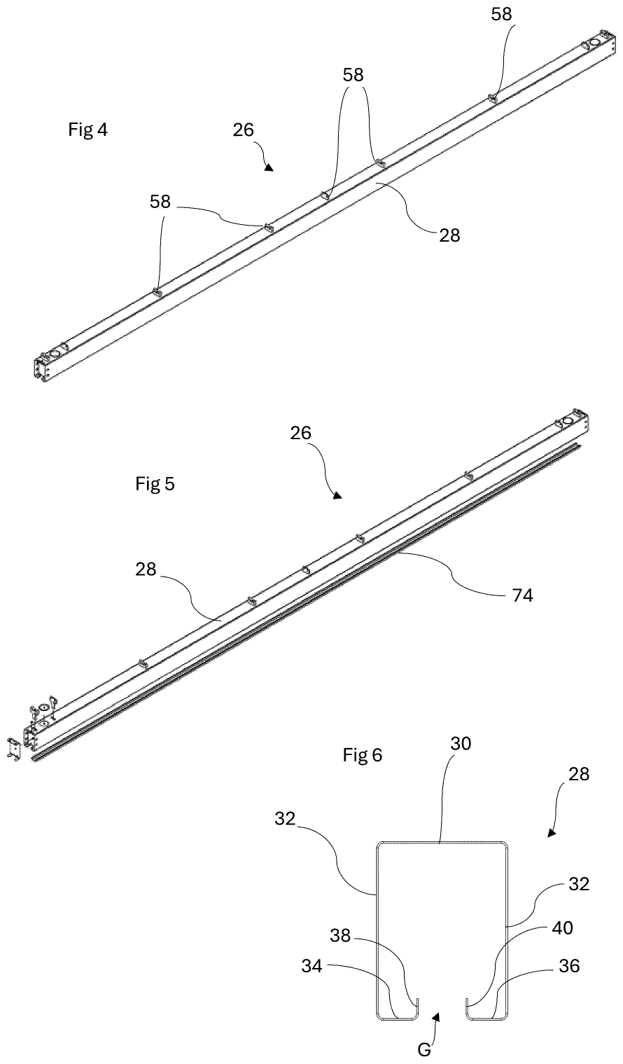

FIGS. 4 and 5 show a composite beam 26 according to one form of the present disclosure. FIG. 5 shows the composite beam 26 in exploded view. The composite beam 26 is elongate and comprises a hollow outer shell 28 formed as a C-section beam, which, in some forms of the present disclosure, is a steel C-section beam.

The outer shell 28 is shown in end view in FIG. 6 and shows that the shell 28 has a closed end wall 30, a pair of side walls 32 that extend generally perpendicular to the end wall 30 and generally parallel to each other. Opposite the end wall 30 is a pair of end wall sections 34, 36. The closed end wall 30, the side walls 32 and the end wall sections 34, 36 form what might be understood to be a regular C-section configuration, whereby the ends of the end wall sections 34, 36 are spaced apart and define an elongate gap G between the end wall sections 34, 36.

The outer shell 28 further includes inwardly extending lips 38, 40, that extend in a direction towards the closed end wall 30, so that they extend inwardly into the interior of the outer shell 28. In FIG. 6, the inwardly extending lips 38, 40 extend generally parallel to each other and to the sidewalls 32, although they could extend at an acute or obtuse angle in other forms of the disclosure. Also, the disclosure covers arrangements in which only one of the lips 38, 40 is provided rather than both of those lips.

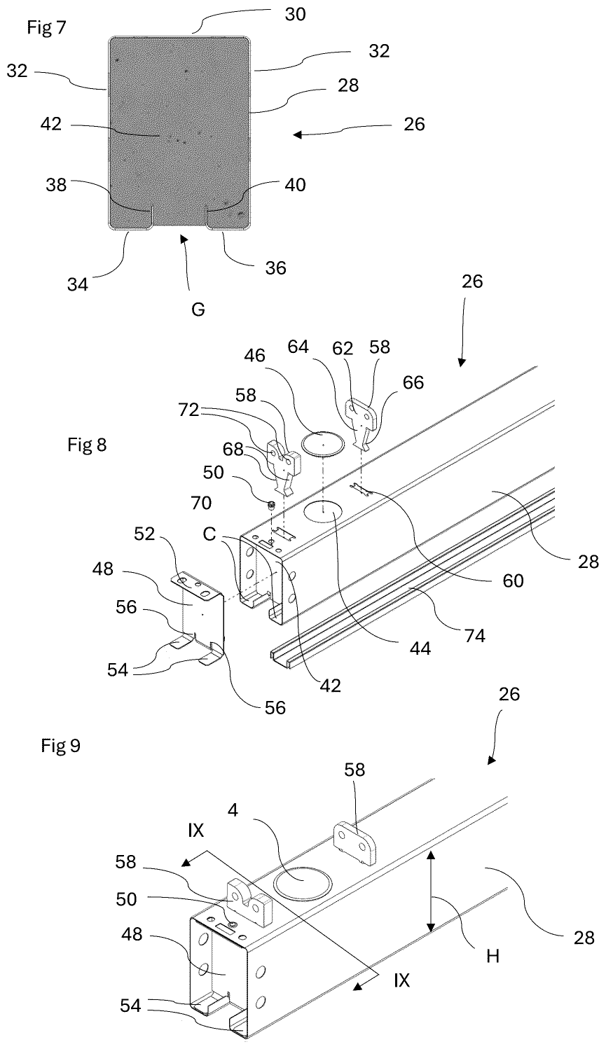

FIG. 7 shows the outer shell 28 filled with concrete 42. Importantly, FIG. 7 shows that the concrete filling substantially fills the interior of the shell 28 and engages about both of the lips 38 and 40. This has alternatively been described earlier herein as enveloping, embedding or encasing the lips 38 and 40.

By engaging the lips 38 and 40 as shown in FIG. 7, the lips 38 and 40 are prevented from buckling and this in turn stiffens the end wall sections 34, 36 from which the lips 38 and 40 extend. This strengthens the shell 28.

The concrete bridges 42 across the gap G between the end wall sections 34, 36 and once the concrete 42 has set or cured, the shape of the composite beam 26 is stabilised and the composite beam 26 behaves like a closed section. The concrete 42 also adds significant weight to the composite beam 26 so that the composite beam 26 can act as a ballast for the PV array 10. Shear and torsion applied to the composite beam 26 will be transferred from one side of the beam 26 to the other by the concrete 42 within the beam 26. This is particularly important as described earlier herein under bending and biaxial loading, as elongate open channel sections, such as C-sections are otherwise susceptible to torsion and buckling.

The engagement between the lips 38 and 40 and the concrete 42 also locks the shell 28 to the concrete 42. This is by the concrete 42 actually embedding the lips 38 and 40 into the body of the concrete 42. This improves the likelihood that the shell 28 will not delaminate from the concrete 42. If there is no delamination, the composite beam 26 will be stronger.

As shown in FIG. 7, the height of the lips 38 and 40 are about 1/10^{th} of the height H (see FIG. 9) of the side walls 32. As described earlier herein, the lips 38 and 40 can have any suitable height dimension such as ⅕^{th} to 1/20^{th} of the height of the side walls 32. As an example of the dimensions of the composite beam 26, the width of the end wall 30 can be in the order of 75-150 mm, for example 110 mm, while the height H of the sidewalls 32 can be in the order of 75-200 m, for example 150 mm. The width of the end wall sections 34, 36 can be in the order of 15-18 mm, for example 35 mm, while the height H of the lips 38 and 40 can be in the order of 10-30 mm, for example 18 mm. The wall thickness of the shell 28 can be in the order of 0.5-3 mm. The length of the composite beam can be in the order of 1 m-6 m. The steel used for the shell 28 can be a high strength, precoated steel, such as G450 ZM250, while the concrete can be 30-40 MPa.

FIGS. 8 and 9 are exploded and assembled views of one end of the composite beam 26 of earlier FIGS. 4 and 5 respectively. With reference to FIG. 8, this shows the outer shell 28 having the form described above and with the concrete 42 filling the interior of the shell 28. FIG. 8 shows an opening 44 in the end wall 30 of the shell 28 and that opening 44 is used for feeding the liquid or flowable concrete into the interior of the shell 28. Once sufficient concrete has been fed into the shell 28, a plug 46 can be inserted into the opening 44 to close the opening 44. The plug 46 is shown in the closed position in FIG. 9.

FIG. 8 also shows an end cap 48 that is configured to fit into the interior of the end of the shell 28 to close the end of the shell 28. A rivnut 50 can be inserted through aligned holes in the end wall 30 of the shell 28 and in the upper lip 52 of the end cap 48 to secure the end cap 48 in the end of the shell 28. The same arrangement is employed at the opposite end of the composite beam 26. The end caps 48 close the opposite ends of the shell 28 so that concrete 42 poured into the shell 28 does not flow out of the opposite ends of the shell 28. It can be seen from FIG. 8, that the end cap 48 has a pair of spaced apart bottom lips 54 that fit within channels C formed by the sidewalls 32, the end wall sections 34, 36 and the lips 38 and 40. The end cap 48 also includes slots 56 to receive the lips 38 and 40. Receipt of the bottom lips 54 within the channels C and receipt of the lips 38 and 40 in the slots 56, in addition to the use of the rivnut 50, secures the end cap 48 firmly in place. FIG. 9 illustrates the end cap 48 installed within the open end of the composite beam 26.

FIG. 8 also shows structural connectors or studs 58. The studs 58 are fitted through openings 60 in the end wall 30 of the shell 28 and can be fitted either before or after the concrete 42 is poured through the opening 44. If the studs 58 are inserted through the openings 44 after the concrete 42 has been poured through the opening 44, the studs 58 need to be inserted before the concrete 42 has set or cured, so that the studs 58 can push through the concrete 42. FIG. 8 shows two studs 58, but as will be apparent from FIGS. 4 and 5, studs 58 are installed along the length of the composite beam 26. The two studs 58 shown in FIG. 8 have different configurations, whereby the stud 58 closest to the end of the composite beam 26 end is used to connect a PV module to the composite beam 26, while the other stud 58 is used to connect the tether 14 (See FIG. 1) to the composite beam 26.

The studs 58 shown in FIG. 8 have a head 62, a neck 64 that is connected to the head 62, and a shoulder 66 that is connected to the neck 64. The neck 64 has inclined side walls 68 that mutually incline from a wide position adjacent the head 62 to a narrow position adjacent the shoulder 66. The width of the shoulder 66 as measured in a direction between the side walls 32, is less than the width of the opening 60 so that the shoulder 66 can easily fit through the opening 60.

As the studs 58 are inserted through the openings 60, the side walls 68 eventually engage against the edges of the openings 60. The opposite ends of the openings 60 include foldable tabs 70 that fold inwardly into the interior of the shell 28 as frictional engagement between the side walls 68 of the studs 58 and the tabs 70 increase. The tabs 70 then form barbs against the side walls 68 resisting reverse movement of the studs 58 out of the openings 60. The studs 58 are shown in installed positions in FIG. 9 with the upper sections of the side walls 68 in frictional engagement with the tabs 70, noting that the tabs 70 will have folded inwardly upon insertion of the studs 58 into the openings 60. The studs 58 will also likely be in contact with one or both of the long sides of the openings 60, with all of that contact comprising electrical contact between the shell 28 and the studs 58 (assuming the studs 58 formed from a conductive metal).

The shoulder 66 forms an undercut to interlock with the concrete 42 once the concrete 42 has cured. This further resists reverse movement of the studs 58 out of the openings 60. The studs 58 provide a connection between the shell 28 and the concrete 42 and each stud 58 incrementally increases the strength of the composite beam 26 by increasing the composite behaviour between the shell 28 and the concrete 42.

The head 62 of the studs 58 can also comprise openings 72, principally for connection to hinges that form part of the PV modules, although as described earlier herein, the studs 58 can alternatively be used for jigging, or for packaging or bracing of the composite beam, or for connection of tether anchors.

FIG. 8 further illustrates a closure member 74 that employed to close the elongate gap G between the end wall sections 34 and 36. Advantageously, closure of the gap G prevents flow of cement 42 through the gap G and out of the interior of the shell 28 when cement 42 is being fed into the interior of the shell 28. As shown in FIG. 5, the closure member 74 is elongate and has a length substantially equal to the length of the shell 28, although as is apparent from FIG. 9, the closure member 74 does not extend to the end edge of the shell 28 but rather, extends slightly inboard of the end edge to allow insertion of the end caps 48.

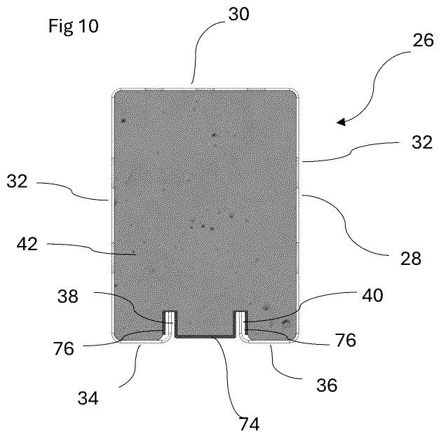

While FIG. 7 is an end view of the composite beam 26 with the end cap 48 removed, FIG. 10 is taken through IX-IX of FIG. 9 and shows the closure member 74 in place. It can be seen from FIG. 10, that the closure member 74 extends or bridges across the gap G to form a barrier against passage of cement 42 through the gap G. The closure member 74 can be installed prior to cement 42 being fed into the interior of the shell 28 through the opening 44. The closure member 74 can be installed prior to the end caps 48 being installed, although installation of the closure member can be made after one of the end caps 48 is installed and prior to the other end cap 48 being installed. In a preferred method, the closure member 74 is installed first and then the end caps 48 and rivnut 50 are installed. The closure member 74 is conveniently installed by sliding it from one end of the shell 28 to the opposite end. The studs 58 can then be inserted in the holes 60 and the concrete is then poured into the shell 28.

The closure member 74 connects to the lips 38 and 40 by the opposite longitudinal edges 76 of the closure member 74 forming a recess to closely receive the lips 38 and 40. The recesses have a depth substantially equal to the height of the lips 38 and 40. The recesses are a close fit with the lips 38 and 40.

The closure member 74 further comprises a bridging member 78 that extends from the opposite longitudinal edges 76 and across the gap G.

The closure member 74 can be formed from plastic for example and have sufficient strength only to prevent flow of cement out of the gap. A suitable plastic can be PVC. The closure member 74 can be manufactured cheaply and without long term durability in mind, as it will be understood that once the cement 42 has cured, the closure member 74 is no longer operational. The closure member 74 is only operational while the concrete 42 is being fed into the interior of the shell 28 and until the concrete 42 cures.

It will also be evident that the closure member 74 could have different forms, and for example, the opposite longitudinal edges 76 can be formed other than to define recesses and for example, the closure member could simply have a top hat configuration, where by opposite longitudinal edges of the closure member simply rest or sit on top of the lips 38 and 40.

Advantageously, the closure member 74 facilitates filling of the shell 28 with concrete 42 without requiring the shell 28 to be a closed section. The advantages of the present disclosure that are provided by the shell 28 being a C-section, are facilitated by the use of the closure member 74. In addition, use of the closure member 74 provides a uniform finish to the composite beam 26 in the gap G between the end wall sections 34 and 36.

The shell 28 can be roll formed using relatively low cost and readily available manufacturing equipment which can achieve high throughput. This is enabled to a major extent by the open section geometry of the shell 28. By comparison, closed sections made from precoated steels often require expensive and complex equipment to create seamed joints, which also impacts corrosion performance, or high cost equipment to seam weld steel which typically needs to be post coated, which adds complexity and cost to the manufacturing process.

A method of manufacturing the composite beam 26 can comprise the following steps: a. The steel shell 28 is rollformed from slit coil (all required holes are punched out during process). b. End caps 48 are inserted. c. Studs, in the form of tether and hinge plates as required are inserted and positioned. d. The beam is flipped and inserted into a concrete filling jig (the jig maintains shape of the shell 28 so that the shell 28 stays dimensionally correct and flat) and concrete is poured through the gap G (and in this method, the opening 44 is not required). e. Optionally, multiple beams can be formed into a single pack (for example 10 beams). f. The jig is levelled flat. g. The composite beams 26 are left to cure.

Various methods can be used to pour concrete through the opening 4, for example, by hand, by automated machine. Vibration can be applied to influence fill consistency.

Another method of manufacturing the composite beam 26 comprises the following steps: a. The steel shell 28 is rollformed from slit coil (all required holes are punched out during process). b. End caps 48 and closure member 74 inserted. c. Tether and Hinge plates as required are inserted and positioned. d. The beams are inserted into a concrete jig (jig set at 15 degree angle, for example). f. Optionally, multiple beams can be formed into a single pack (for example 10 beams). g. Concrete is poured through the opening 44 (vibration can be applied to influence fill consistency). h. The composite beams 26 are left to set.

A variation on option 2 exists whereby the closure member is a temporary member and is removable. This could be a discrete seal per composite beam, or a single seal for multiple beams. Other methods to fill the beam may be used, for example, sealing or not providing the opening 44 and pouring the concrete through one of the ends of the shell 28.

The composite beam described herein has enabled the use of readily available high strength, precoated cold formed steels, at much thinner gauges than an equivalent closed steel section, or open section, substantially lowering the cost of the composite beam.

The composite beam described herein can use 30-35% less steel than a closed section of an equivalent steel grade (450 MPa) and primary dimensions.

The composite beam described herein can use approximately 40-45% less steel than a closed section of the same primary dimensions but in a more commonly available lower grade hot rolled steel (350 MPa) and uses 50-60% less steel than the same section without concrete.

The section profile of the outer shell is such that precoated steels can be used and are not damaged ensuring strong corrosion performance. No post coating is required, reducing manufacturing costs.

Low capex and readily available rollforming equipment can be used to produce the section.

The cross-sectional dimensions and steel gauge can be easily adjusted to suit required strength.

The composite beam described herein provides for high capacity structural connections with high durability. These connections improve the strength of the beam, rather than reducing as other connection methods might.

One or more features expected to be provided by the composite beam described herein comprise: high strength, high durability, small cross section, long, low cost, high tolerance, high throughput structural member, can handle biaxial loading, can be supported easily; high strength steels, stable cross section under biaxial bending and torsion, 30+ year design life in highly corrosion environments, low cost, allows for thin gauge steel, easy to manufacture with lower cost capex, high throughput, rapid primary and secondary assembly processes for high volumes, high tolerance, provision for earthing.

Where any or all of the terms “comprise”, “comprises”, “comprised” or “comprising” are used in this specification (including the claims) they are to be interpreted as specifying the presence of the stated features, integers, steps or components, but not precluding the presence of one or more other features, integers, steps or components.

Those skilled in the art will appreciate that the invention described herein is susceptible to variations and modifications other than those specifically described. It is understood that the invention includes all such variations and modifications which fall within the spirit and scope of the present invention.

1. An elongate composite beam for securing or anchoring a solar array, comprising:
a. a hollow outer shell formed from a C-section beam that has a closed end wall, a pair of side walls extending from the end wall, end wall sections that extend inwardly towards each other from ends of the side walls remote from the closed end wall, opposed ends of the end wall sections being spaced apart to define an elongate gap between the end wall sections, the closed end wall, the side walls and the end wall sections defining a shell interior, and at least one of the end wall sections comprising an inwardly extending lip that extends in a direction towards the closed end wall inwardly into the interior,
b. the interior of the shell being substantially filled with a settable material which engages about the inwardly extending lip.

2. A composite beam according to claim 1, the hollow outer shell being formed from a steel C-section beam.

3. A composite beam according to claim 1, the settable material being concrete.

4. A composite beam according to claim 1, the inwardly extending lip extending at an acute or an obtuse angle to the end wall section from which it extends.

5. A composite beam according to claim 1, the inwardly extending lip extending generally perpendicular to the closed end wall and generally parallel to the end wall section from which it extends.

6. A composite beam according to claim 1, the inwardly extending lip extending along substantially the full elongate gap.

7. A composite beam according to claim 1, each of the end wall sections comprising an inwardly extending lip that extends in a direction towards the closed end wall inwardly into the interior and the concrete engaging about each inwardly extending lip.

8. A composite beam according to claim 7, the inwardly extending lips extending along substantially the full elongate gap.

9. A composite beam according to claim 1, the outer shell comprising one or more openings through which concrete can be fed or pumped into the shell.

10. A composite beam according to claim 1, the outer shell comprising one or more openings for receipt of or to accommodate one or more studs.

11. A composite beam according to claim 10, the one or more studs being shaped or configured to interlock with the concrete once the concrete has cured.

12. A composite beam according to claim 11, the one or more studs has an embedded section for embedding into the concrete and the embedded section has an expansion that forms an undercut to interlock with the concrete to resist removal of the stud out of the opening.

13. A composite beam according to claim 11, the one or more studs comprising a head, a neck that is connected to the head, and a shoulder that is connected to the neck, remote from the head, whereby the head abuts against an outer surface of the shell and the shoulder forms an undercut to interlock with the concrete.

14. A composite beam according to claim 11, the one or more studs being formed from an electrically conductive metal, so that the stud can form an earth or ground for a PV array which is connected to the composite beam.

15. A composite beam according to claim 11, the opening through which the stud extends forming a friction fit with the stud.

16. A composite beam according to claim 15, the opening comprising foldable tabs that fold inwardly into the interior of the shell as frictional engagement between the side walls of the stud and the tabs increase, whereby the tabs form barbs against the side walls resisting reverse movement of the stud out of the opening.

17. A composite beam according to claim 1, comprising a closure member to close the elongate gap between the end wall sections.

18. A composite beam according to claim 17, the closure member connecting to the inwardly extending lip of the end wall section.

19. A composite beam according to claim 18, the closure member comprising a recess to closely receive at least a portion of the lip.

20. A composite beam according to claim 19, when dependent on claim 7, the closure member comprising a pair of recesses to closely receive at least a portion of each of the lips.
